(19) United States
(12) Patent Application Publication
(10) Pub. No.: US 2004/0145885 A1
(43) Pub. Date: Jul. 29, 2004

(54) Illuminative device for gauge face

(76) Inventor: Kuan-Hsu Chen, Taipei (TW)

Correspondence Address: BIRCH STEWART KOLASCH & BIRCH, PO BOX 747, FALLS CHURCH, VA, 22040-0747, US

(21) Appl. No.: 10/351,512

(22) Filed: Jan. 27, 2003

(51) Int. Cl. G01D 11/28

(52) U.S. Cl. 362/28; 362/23

(57) ABSTRACT

Gauge face lighting includes an illuminative device disposed on top of a gauge face with mechanical meters; the device features on that the illuminative device is composed by a circular light guiding loop and a plurality of grooves. A plurality of light-emitting diode is disposed inside the grooves respectively. Thus the homogeneous light emits circularly from the light guiding loop for better lighting on the surface of the gauge face with mechanical meters.

### BACKGROUND OF THE INVENTION

1. Field of the Invention

The present invention relates to lighting of gauge face, especially to an illuminative device for gauge face that is composed of a plurality of light-emitting diode disposed on a light guiding loop so that the light guiding loop emits homogeneous light circularly for better lighting effect on the gauge face with mechanical meters.

2. Description of the Prior Art

It is known to construct lights for the gauge face inside vehicles for drivers to easily check on the meters. Gauge face lights of this kind are typically small-sized bulbs or light-emitting diode. These lights are installed at the rim of the gauge face, providing uneven lighting effects for meters on the gauge face.

The gauge face lighting system, referring to ROC Patent No. 505120, applies to gauge faces used in a variety of machines, providing different colors and luminance. The gauge face lighting system includes a middle base layer and an illuminative device, installed between the transparent cover of the gauge face and the meters. On one side of the middle base layer, there is the first concave; on the other side, there is the second concave. On the surface of the middle base layer are letters, figures, degrees, graphics made by carbon dioxide etching techniques. Illuminative device is fitted into the first concave and is powered by a control circuit. The second concave is to accommodate the pointers of the meters. The pointers point to the corresponding letters or figures. When the illuminative devices send out light rays that make the entire middle base layer gleam, each letter or figures shows equivalent colors and luminance.

Since the middle base layer covers the whole gauge face and the arrangement of the meters on the gauge face varies, the second concave of the middle base layer has to fit with the specific arrangement of meters. That is to say, manufacturers have to make specific middle base layer for different designs of gauge faces, which inevitably leads to the increase of cost.

Further, the first concave that accommodates illuminative device is located at the rim of the middle base layer. The meters that are relatively far away from the illuminative device receive less light than those that are close to the illuminative device. With this design, not all meters on the gauge face can receive equal amount of luminance and thus still have problems with lighting.

### SUMMARY OF THE INVENTION

It is therefore a primary object of the present invention to provide an illuminative device for gauge face in which an illuminative device for night vision disposed on top of the meters. The lighting construction includes a light guiding loop, on which there is a plurality of grooves. A plurality of light-emitting diodes is set inside these grooves. According to the above construction, the innovative light guiding loop lighting loop provides equal luminance for the meters of the gauge face.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an explosive view of the present invention;

FIG. 2 is a cross sectional assembling view of the present invention;

FIG. 3 is an explosive view of another embodiment of the present invention;

FIG. 4 is a cross sectional assembling view of another embodiment of the present invention;

FIG. 5 is an explosive view of a further embodiment of the present invention;

FIG. 6 is a cross sectional assembling view of a further embodiment of the present invention.

### DETAILED DESCRIPTION OF THE PREFERRED EMBODIMENT

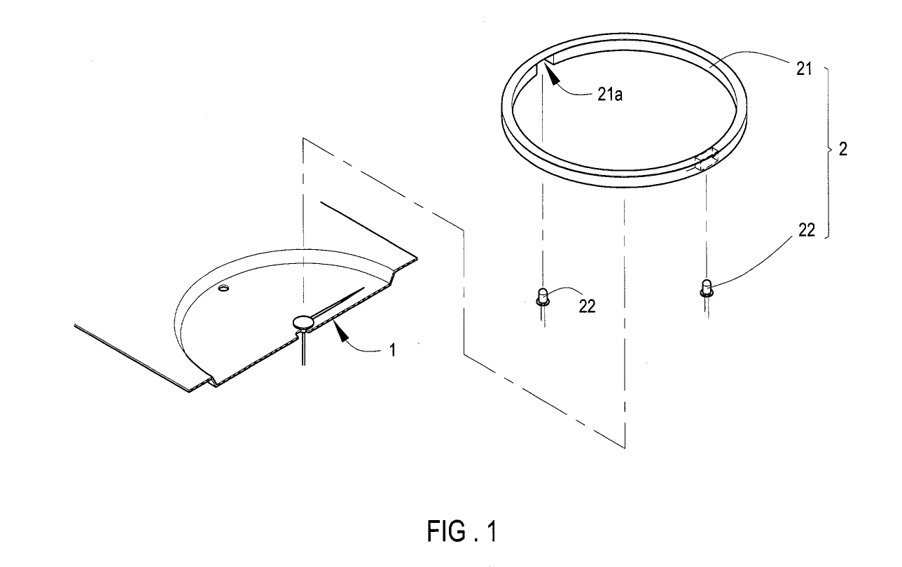

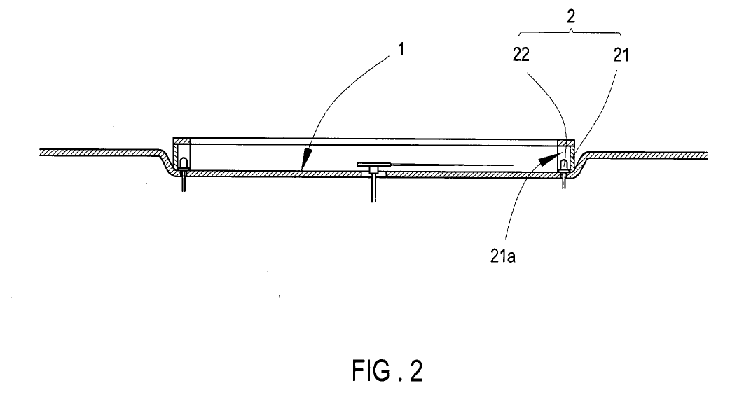

Refer to FIG. 1 & FIG. 2, the present invention includes an illuminative device 2 for night vision disposed on the top side of a gauge 1 (either mechanical or electrical one).

The device is featured on that:

The illuminative device 2 is composed of a circular light guiding loop 21 with a plurality of grooves 21 a thereof. A light-emitting diode 22 is disposed in each groove 21a.

In accordance with the structure mentioned above, the light-emitting diode 22 inside each groove 21 a of the circular light guiding loop21 emits light and the light guiding loop21 makes the light irradiate rounding the surface of the gauge 1 so as to provide homogeneous illumination for better indicating effect.

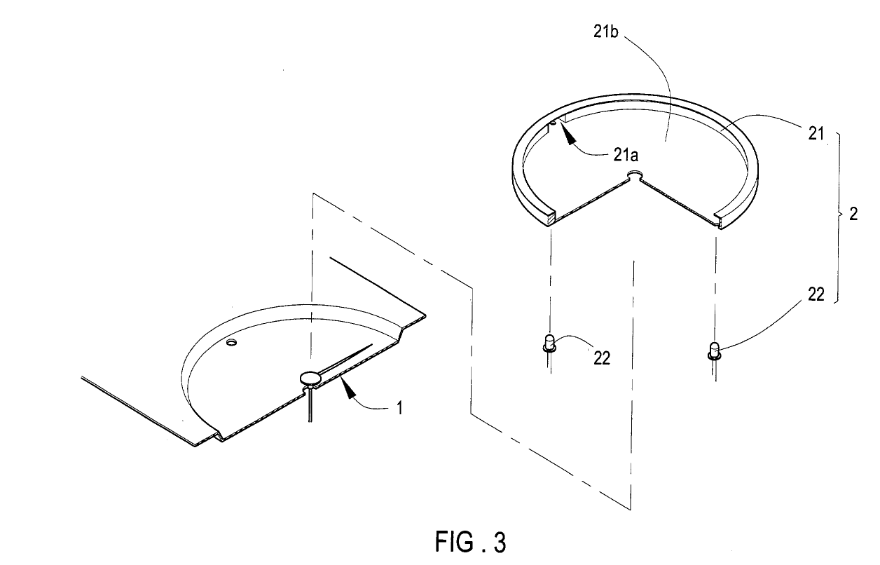

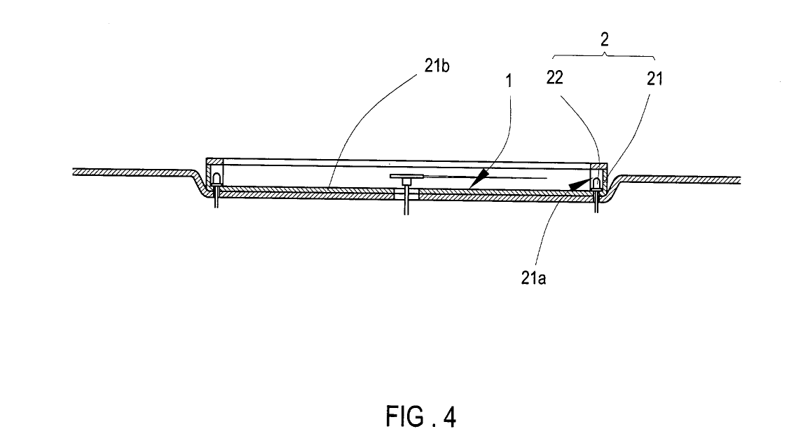

Referring to FIG. 3 & FIG. 4, a light guiding plane 21b extends from the inner circular side of the light guiding loop21 so that the light from the light-emitting diode 22 irradiates the surface of the gauge 1 through the light guiding plane 21b so as to enhance the effect of illumination. This. is another embodiment of the present invention.

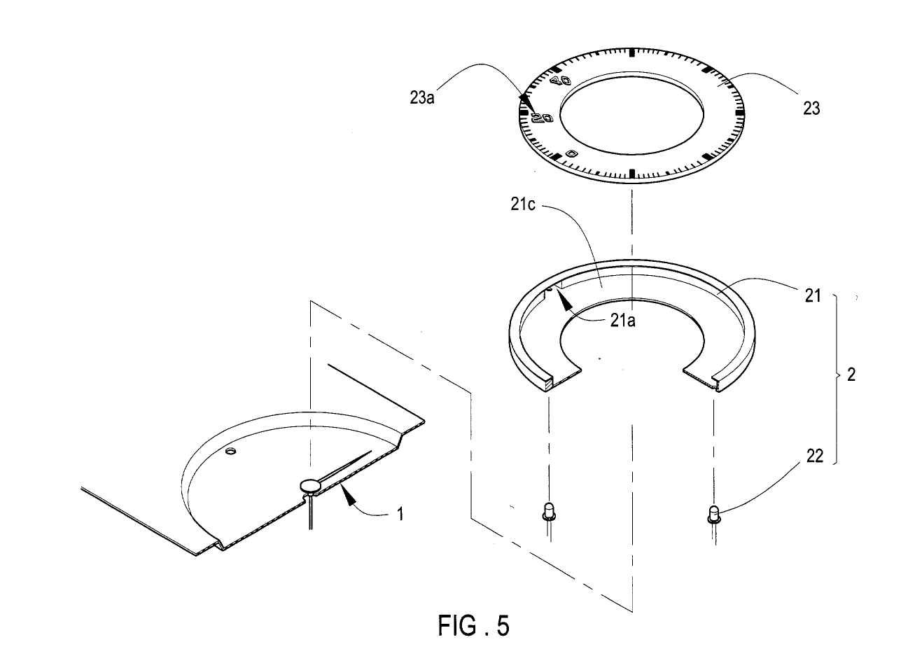

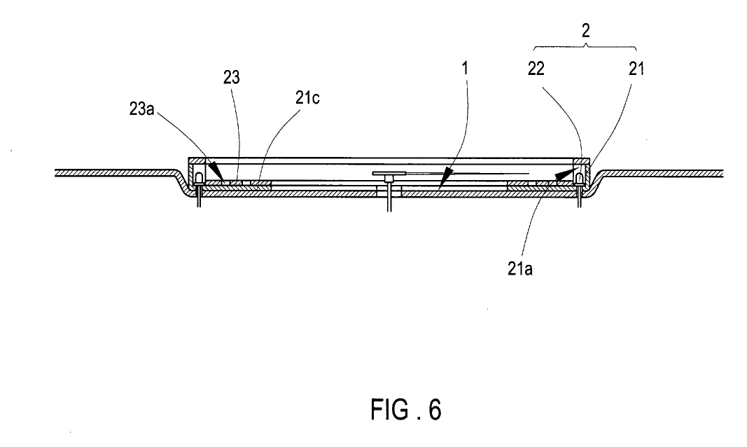

Refer to FIG. 5 & FIG. 6, a projecting loop 21c extends from the inner circular side of the light guiding loop21. A graduated ring 23 with cutout letters 23a is disposed above the projecting loop 21c so that the light from the light-emitting diode 22 can be reflected by the projecting loop 21c and then arrives the graduated ring 23. Thus the cutout letters 23a on the graduated ring 23 shows homogeneous light for indication. The cutout letters 23a can also be numbers, characters, degrees, or figures. This is a further embodiment of the present invention.

It should be noted that the above description and accompanying drawings are only used to illustrate some embodiments of the present invention, not intended to limit the scope thereof. Any modification of the embodiments should fall within the scope of the present invention.

1. An illuminative device for gauge face comprising
an illuminative device for night vision disposed on top side of a gauge face with mechanical meters; wherein the improvements of the gauge face lighting is characterized in that:
said illuminative device having a circular light guiding loop with a plurality of grooves and a plurality of light-emitting diode arranged inside said groove for providing homogeneous light for said gauge face with mechanical meters.

2. An illuminative device for gauge face as claimed in claim 1, wherein a light guiding plane extends from the inner circular side of said light guiding loop for reflecting light from said light-emitting diode to light the surface of said gauge face with mechanical meters.

3. An illuminative device for gauge face as claimed in claim 1, wherein a projecting loop extends from the inner circular side of said light guiding loop and a graduated ring with cutout letters is disposed above said projecting loop so that the light from light-emitting diode is reflected by said projecting loop and passing through said cutout letters, showing homogeneous light for indication.
